(19) United States
(12) Patent Application Publication
(10) Pub. No.: US 2010/0266056 A1
(43) Pub. Date: Oct. 21, 2010

(54) METHOD AND APPARATUS FOR SCHEDULING MULTIPLE USERS IN A MULTIPLE-INPUT MULTIPLE-OUTPUT SYSTEM

(75) Inventors: Seung-Hwan Lee, Daejeon (KR); Jin Up Kim, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS INSTITUTE, Daejeon (JP)

(21) Appl. No.: 12/562,231

(22) Filed: Sep. 18, 2009

(30) Foreign Application Priority Data
Apr. 20, 2009 (KR) 10-2009-0034369

(51) Int. Cl. H04L 27/28

(52) U.S. Cl. 375/260

(57) ABSTRACT

A multi-user scheduling method and apparatus in a Multiple-Input Multiple-Output (MIMO) system are disclosed. The multi-user scheduling method includes calculating a valid channel norm based on statistical characteristics of a channel for every user terminal, selecting a user set that maximizes the sum of valid channel norms and that includes as many user terminals as data are transmittable to simultaneously, and precoding transmission signals for the user terminals included in the user set according to a predetermined scheme. According to the present invention, the volume of computation required for multi-user selection is reduced greatly, thus making real-time implementation possible.

### CROSS-REFERENCE TO RELATED APPLICATION

This application claims the benefit of Korean Application No. 10-2009-0034369, filed on Apr. 20, 2009 in the Korean Intellectual Property Office, the disclosure of which is incorporated herein by reference.

### BACKGROUND OF THE INVENTION

1. Field of the Invention

The present invention relates to a method and apparatus for scheduling multiple users, taking into account implementation complexity and performance in a multi-user Multiple-Input Multiple-Output (MIMO) system.

2. Description of the Related Art

A MIMO system may offer very high transmission efficiency by multiplexing gain and increase transmission reliability by diversity gain, as well. Especially, a multi-user MIMO system designed for a multi-user environment may further increase the transmission efficiency by multi-user diversity gain.

In the multi-user MIMO system, however, the number of users to which data are transmittable simultaneously does not exceed that of Base Station (BS) antennas. When a BS is to service more users than the number of the antennas, it selects users according to a predetermined condition. As there are more users and more BS antennas, complexity increases. For example, for K users and M_{T} BS antennas, a sum-rate maximization rule is used to select a user set that maximizes sum-rate capacity. The sum-rate maximization rule is an algorithm of calculating a predicted sum-rate capacity for every possible user set and selecting a user set with the largest sum-rate capacity. This algorithm requires

$${\sum }_{i = 1}^{M} ( \begin{matrix}K \\ i\end{matrix} )$$

computations of sum-rate capacity. Although the multi-user scheduling algorithm provides a maximum sum-rate capacity in theory, the large computation load makes real implementation of the multi-user scheduling algorithm impossible.

To increase the sum-rate capacity and reduce the computation complexity, a method has been provided, in which a channel norm is calculated for every user and a user set with minimal interference between users is selected.

However, this method has the following shortcoming. While channel information is essential to precoding in the MIMO environment, scheduling delay exists for an actual time-varying MIMO channel due to the time difference between channel information acquisition and actual use of channel information. The scheduling delay degrades multi-user scheduling performance as well as MIMO precoding performance. In other words, when a timely service is not provided to a user experiencing a great channel change, the error of channel information is further increased, leading to an actual decrease in sum-rate capacity.

Fast servicing of a user experiencing a fast channel change and slow serving of a user experiencing a slow channel change by multi-user scheduling may minimize performance degradation. Yet, the foregoing method may cause performance degradation in view of Doppler spread in its application to a mobile communication environment because it performs user scheduling with no regard to statistical characteristics of channels. Moreover, since users with minimal interference among them are selected, the sum of the channel norms of the users that determines a total sum-rate capacity may be small despite the minimal interference. Accordingly, the user selection may not be optimal.

### SUMMARY OF THE INVENTION

Therefore, the present invention has been made in view of the above problems, and it is an object of the present invention to provide a multi-user scheduling method and apparatus for minimizing performance degradation and reducing implementation complexity by combining a user selection scheme considering statistical characteristics of channels with a precoding scheme for actively canceling interference among selected users in a MIMO system.

In accordance with an aspect of the present invention, the above and other objects can be accomplished by the provision of a multi-user scheduling method in a MIMO system, including calculating a valid channel norm based on statistical characteristics of a channel for every user terminal, selecting a user set that maximizes the sum of valid channel norms and that includes as many user terminals as data are transmittable to simultaneously, and precoding transmission signals for the user terminals included in the user set according to a predetermined scheme.

In accordance with another aspect of the present invention, there is provided a multi-user scheduling apparatus in a MIMO system, including a controller for calculating a valid channel norm based on statistical characteristics of a channel for every user terminal and selecting a user set that maximizes the sum of valid channel norms and that includes as many user terminals as data are transmittable to simultaneously, and a pre-processor for precoding transmission signals for the user terminals included in the user set according to a predetermined precoding scheme.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a multi-user MIMO system to which a multi-user scheduling method according to an exemplary embodiment of the present invention is applied;

FIG. 2 illustrates a frame structure and a slot structure used for the multi-user scheduling method according to the exemplary embodiment of the present invention;

FIG. 3 is a flowchart illustrating the multi-user scheduling method according to the exemplary embodiment of the present invention;

FIG. 4 is a graph illustrating simulation results of the performance of multi-user scheduling methods according to exemplary embodiments of the present invention; and

FIG. 5 is a graph illustrating the computation complexities of a multi-user scheduling method according to an exemplary embodiment of the present invention.

### DETAILED DESCRIPTION OF THE PREFERRED EMBODIMENTS

Exemplary embodiments of the present invention will be described with reference to the attached drawings. In the following description, the terms “user” and “user terminal” are interchangeably used in the same meaning.

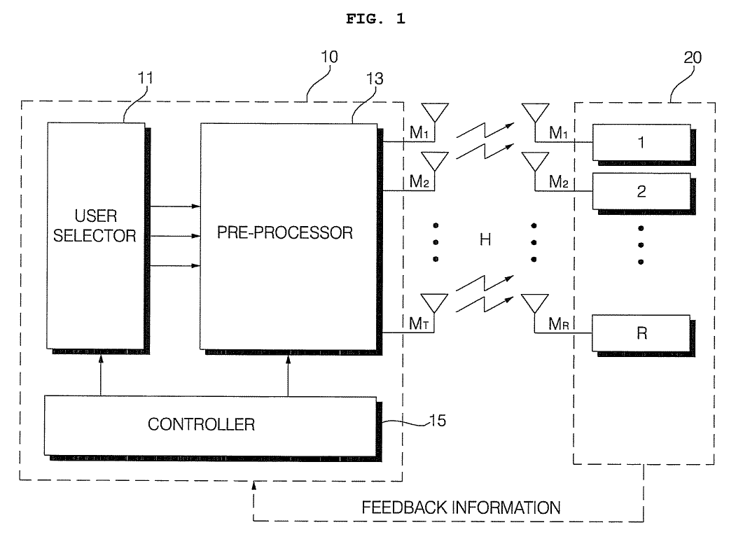

FIG. 1 is a block diagram of a multi-user MIMO system to which a multi-user scheduling method according to an exemplary embodiment of the present invention is applied. Referring to FIG. 1, the MIMO system includes a transmission apparatus 10 such as a BS and a reception apparatus 20. The transmission apparatus 10 may include a user selector 11, a pre-processor 13, and a controller 15. The controller 15 determines a user set including as many user terminals as data are simultaneously transmittable to in a later-described method. The user selector 11 provides transmission signals destined for the user terminals of the determined user set to the pre-processor 13. The pre-processor 13 performs MIMO precoding on the received transmission signals in a predetermined method.

The transmission apparatus 10 may have M_{T} transmit antennas and the reception apparatus 20 may have M_{R} receive antennas, each receiver having a single antenna. Hence, data may be transmitted simultaneously to as many user terminals as the number of antennas selected by the transmission apparatus 10 and the reception apparatus 20.

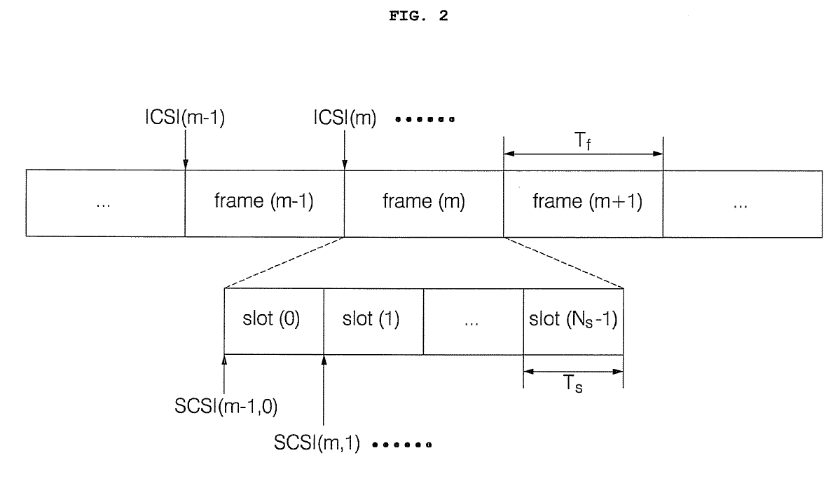

FIG. 2 illustrates a frame structure and a slot structure used for the multi-user scheduling method according to the exemplary embodiment of the present invention.

Referring to FIG. 2, one frame has a time duration of T_{f}, including Nₛ slots each being Tₛ long.

In accordance with the present invention, it is assumed that Instant Channel State Information (ICSI) is updated in every frame and Statistic Channel State Information (SCSI) is calculated at the start of each slot, for MIMO precoding. Under this condition, a multi-user scheduling method for a time-varying MIMO channel may minimize scheduling delay-incurred performance degradation by distributing user terminals that transmit signals based on SCSI, appropriately in time and space. The multi-user scheduling method of the present invention is performed as follows in every slot in order to reduce implementation complexity.

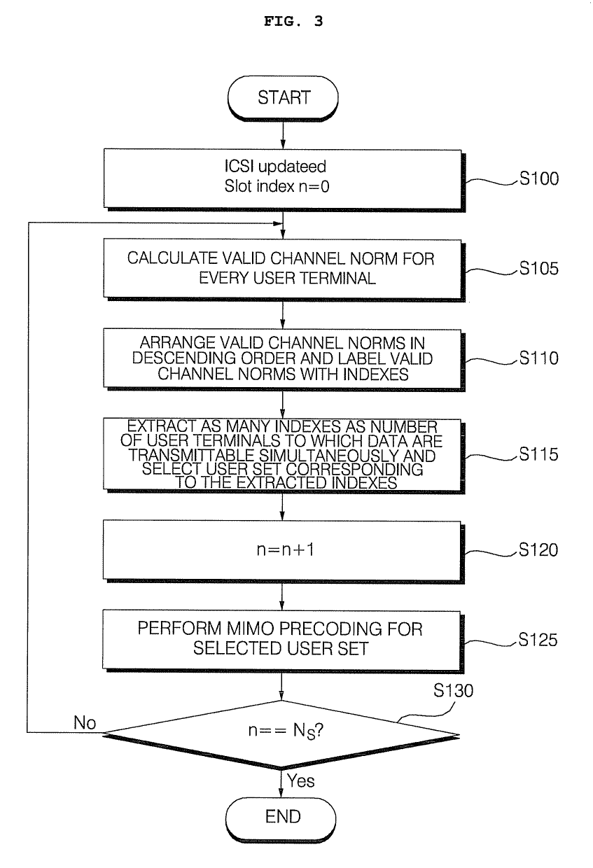

FIG. 3 is a flowchart illustrating the multi-user scheduling method according to the exemplary embodiment of the present invention. Referring to FIG. 3, the controller 15 updates ICSI and sets a slot index n to an initial value 0 in step S100. In step S105, the controller 15 calculates a valid channel norm for every user terminal, taking into account statistical characteristics of channels, by the following equation.

$${‖ {h}_{e}^{k} ( {nT}_{s} ) ‖}^{2} = \frac{{ρ}_{k}^{2} ( {nT}_{s} )}{1 - {ρ}_{k}^{2} ( {nT}_{s} )} {‖ {h}_{0}^{k} ‖}^{2} \qquad [ Equation 1 ]$$

where ∥h₀^{k}∥ denotes the channel norm of ICSI received from a k^{th} user terminal at the start of every frame ∥hₑ^{k}(nTₛ)∥ denotes a valid channel norm determined according to the scheduling delay of an n^{th} slot for the k^{th} user terminal, and ρₖ(nTₛ)=J₀(2πf_{d}^{k}nTₛ) denotes the temporal correlation of a channel for the k^{th} user terminal, determined by a Doppler spread f_{d}^{k} and a time delay nTₛ. J₀ is a 0^{th}-order Bessel function.

Then the controller 15 arranges the calculated valid channel norms in a descending order from a maximum valid channel norm to a minimum valid channel norm and labels the valid channel norms with indexes in the arranged order in step S110. The controller 15 sequentially extracts indexes as many as or fewer than the number of antennas of the transmission apparatus and selects a user set including user terminals corresponding to the extracted indexes in step S115. The sum of the valid channel norms of the user terminals selected in this manner is always larger than that of the valid channel norms of any other set of user terminals. In other words, a set of user terminals that maximize the sum of valid channel norms is found with use of a simple ordering formula.

The controller 15 updates the slot index n to (n+1) in step S120. The user selector 11 provides transmission signals for the user terminals of the selected user set to the pre-processor 13 under the control of the controller 15 and the pre-processor 13 performs non-linear MIMO precoding such as Tomlinson-Harashima Precoding (THP) or the like on the transmission signals in step S125. The pre-coded transmission signals are transmitted to the reception apparatus 20 through a predetermined number of antennas of the transmission apparatus 10.

Performance degradation caused by interference between users is minimized by use of the non-linear precoding. On the other hand, a simpler linear MIMO precoding scheme may be used instead of the non-linear MIMO precoding scheme. That is, a MIMO precoding scheme may be selected, taking into account complexity and performance comprehensively.

The above operation is repeated until the updated n value is equal to Nₛ in step S130. In this manner, complexity is reduced, while minimizing performance degradation.

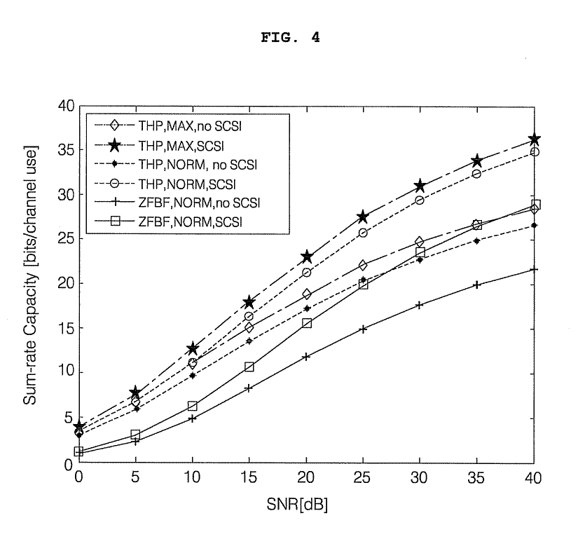

FIG. 4 is a graph illustrating simulation results of the performance of multi-user scheduling methods according to exemplary embodiments of the present invention. It is assumed herein that the number of BS antennas M_{T}=4, the number of users K=20, and a relative Doppler spread f_{d}T_{f} of each user has a uniform distribution over (0.1, 0.5).

Referring to FIG. 4, curve ‘THP, MAX, no SCSI’ represents the performance of a conventional sum-rate maximization rule-based scheduling scheme with no regard to SCSI, and curve ‘THP, MAX, SCSI’ represents the performance of a conventional sum-rate maximization rule-based scheduling scheme taking into account SCSI. Curve ‘THP, NORM, no SCSI’ and curve ‘THP, NORM, SCSI’ respectively represent the performance of a THP precoding-based multi-user scheduling method with no regard to SCSI and the performance of a THP precoding-based multi-user scheduling method taking into account SCSI according to exemplary embodiments of the present invention. Curve ‘ZFBF, NORM, no SCSI’ and curve ‘ZFBF, NORM, SCSI’ respectively represent the performance of a Zero Forcing BeamForming (ZFBF) precoding-based multi-user scheduling method with no regard to SCSI and the performance of a ZFBF precoding-based multi-user scheduling method taking into account SCSI according to exemplary embodiments of the present invention.

It is noted from FIG. 4 that the multi-user scheduling methods of the present invention perform better by using statistical characteristics of channels. Meanwhile, it is revealed that the non-linear THP outperforms the linear ZFBF in terms of sum-rate capacity irrespective of a multi-user selection algorithm.

The valid channel norm-based multi-user selection scheme used in the multi-user scheduling methods of the present invention is outperformed more or less by the conventional sum-rate maximization rule. Nonetheless, the valid channel norm-based multi-user selection scheme has almost the same sum-rate capacity performance across an entire Signal-to-Noise Ratio (SNR) area.

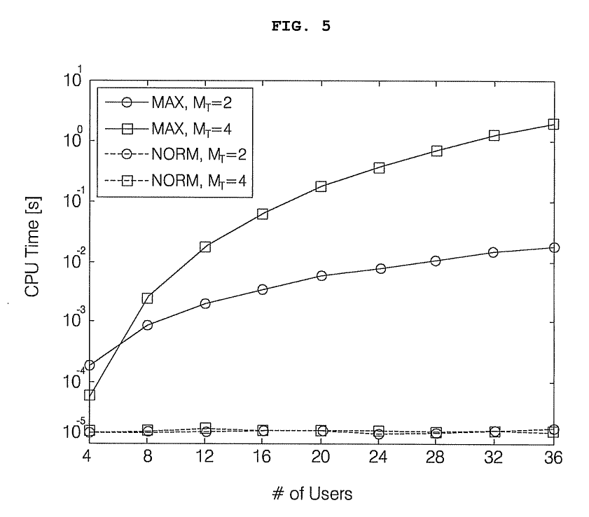

FIG. 5 is a graph comparing a multi-user scheduling method of the present invention with a conventional multi-user scheduling method. In FIG. 5, curves ‘MAX’ represent computation volumes of the conventional sum-rate maximization rule-based scheduling, and curves ‘NORM’ represent computation volumes of the multi-user scheduling method according to the exemplary embodiment of the present invention. M_{T} represents the number of BS antennas.

Referring to FIG. 5, even though the conventional scheduling method may outperform the multi-user scheduling method of the present invention in terms of sum-rate capacity, its computation volume increases steeply in proportion to the number of users and the number of antennas. Therefore, real implementation of the conventional scheduling method is difficult. In contrast, the multi-user scheduling method of the present invention is readily implemented because it requires a very small amount of computation irrespective of an increase in the number of users or the number of antennas.

Meanwhile, exemplary embodiments of the present invention can also be embodied as computer-readable codes on a computer-readable recording medium. The computer-readable recording medium is any data storage device that can store data which can thereafter be read by a computer system. Examples of the computer-readable recording medium include, but are not limited to, Read-Only Memory (ROM), Random-Access Memory (RAM), CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion.

As is apparent from the above description, exemplary embodiments of the present invention considerably reduces the volume of computation required for multi-user selection in a multi-user MIMO system. Although the exemplary embodiments of the present invention may have performance degradation in terms of sum-rate capacity, relative to a theoretical sum-rate capacity, they reduce the volume of computation so greatly as to be readily implemented in real time. Therefore, the exemplary embodiments of the present invention are readily applicable to multi-user scheduling in the multi-user MIMO system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A multi-user scheduling method in a Multiple-Input Multiple-Output (MIMO) system, comprising:
calculating a valid channel norm based on statistical characteristics of a channel for every user terminal;
selecting a user set that maximizes the sum of valid channel norms and that includes as many user terminals as data are transmittable to simultaneously; and
precoding transmission signals for the user terminals included in the user set according to a predetermined scheme.

2. The multi-user scheduling method according to claim 1, wherein the valid channel norm calculation comprises calculating the valid channel norm by the following equation,
$${‖ {h}_{e}^{k} ( {nT}_{s} ) ‖}^{2} = \frac{{ρ}_{k}^{2} ( {nT}_{s} )}{1 - {ρ}_{k}^{2} ( {nT}_{s} )} {‖ {h}_{0}^{k} ‖}^{2}$$
where ∥h₀^{k}∥ denotes the channel norm of ICSI received from a k^{th} user terminal at the start of every frame, ∥hₑ^{k}(nTₛ)∥ denotes a valid channel norm determined according to the scheduling delay of an n^{th} slot for the k^{th} user terminal, ρₖ(nTₛ)=J₀(2πf_{d}^{k}nTₛ) denotes the temporal correlation of a channel for the k^{th} user terminal, determined by a Doppler spread f_{d}^{k} and a time delay nTₛ, and J₀ is a 0^{th}-order Bessel function.

3. The multi-user scheduling method according to claim 1, wherein the user set selection comprises arranging the calculated valid channel norms in a descending order from a maximum valid channel norm to a minimum valid channel norm and selecting a user set including user terminals corresponding to as many valid channel norms as the number of user terminals to which data are simultaneously transmittable.

4. The multi-user scheduling method according to claim 1, wherein the predetermined scheme is MIMO precoding.

5. The multi-user scheduling method according to claim 1, further comprising transmitting the precoded transmission signals to receivers through a predetermined number of transmit antennas.

6. A multi-user scheduling apparatus in a Multiple Input Multiple Output (MIMO) system, comprising:
a controller for calculating a valid channel norm based on statistical characteristics of a channel for every user terminal and selecting a user set that maximizes the sum of valid channel norms and that includes as many user terminals as data are transmittable to simultaneously; and
a pre-processor for precoding transmission signals for the user terminals included in the user set according to a predetermined precoding scheme.

7. The multi-user scheduling apparatus according to claim 6, further comprising a user selector for providing transmission signals for the user terminals included in the user set to the pre-processor under control of the controller.

8. The multi-user scheduling apparatus according to claim 6, wherein the controller calculates the valid channel norm by the following equation,
$${‖ {h}_{e}^{k} ( {nT}_{s} ) ‖}^{2} = \frac{{ρ}_{k}^{2} ( {nT}_{s} )}{1 - {ρ}_{k}^{2} ( {nT}_{s} )} {‖ {h}_{0}^{k} ‖}^{2}$$
where ∥h₀^{k}∥ denotes the channel norm of ICSI received from a k^{th} user terminal at the start of every frame, ∥hₑ^{k}(nTₛ)∥ denotes a valid channel norm determined according to the scheduling delay of an n^{th} slot for the k^{th} user terminal, ρₖ(nTₛ)=J₀(2πf_{d}^{k}nTₛ) denotes the temporal correlation of a channel for the k^{th} user terminal, determined by a Doppler spread f_{d}^{k} and a time delay nTₛ, and J₀ is a 0^{th}-order Bessel function.

9. The multi-user scheduling apparatus according to claim 6, wherein the predetermined scheme is MIMO precoding.

10. The multi-user scheduling apparatus according to claim 6, wherein the pre-processor transmits the precoded transmission signals to receivers through a predetermined number of transmit antennas.
